(19) United States
(12) Patent Application Publication
(10) Pub. No.: US 2023/0356615 A1
(43) Pub. Date: Nov. 9, 2023

(54) METHOD AND SYSTEM FOR ALLOCATING CHARGING RESOURCES TO ELECTRIC VEHICLES

(71) Applicant: GreenFlux Assets B. V., Amsterdam (NL)

(72) Inventors: Lennart Frans VERHEIJEN, Amsterdam (NL); Dzmitry KUHACH, Amsterdam (NL); Raman TSITOU, Amsterdam (NL)

(73) Assignee: GreenFlux Assets B. V., Amsterdam (NL)

(21) Appl. No.: 18/002,532

(22) PCT Filed: Jan. 18, 2022
(86) PCT No.: PCT/NL2022/050017

§ 371 Date: Dec. 20, 2022

(30) Foreign Application Priority Data
Jan. 19, 2021 (NL) 2027345

(51) Int. Cl. B60L 53/63; B60L 53/67; B60L 53/68

(52) U.S. Cl. CPC B60L 53/63; B60L 53/67; B60L 53/68

(57) ABSTRACT

A method is disclosed for allocating charging resources to a plurality of electric vehicles. The electric vehicles are connected to a polyphase power distribution system for receiving said charging resources. The method comprises determining a first connection configuration for a first electric vehicle out of the plurality of electric vehicles by determining that the first electric vehicle is connected to a first subset of one or more phases of the polyphase power distribution system and not connected to a second subset of one or more phases of the polyphase power distribution system. The method also comprises, based on the determined first connection configuration, allocating charging resources to the electric vehicles.

### FIELD OF THE INVENTION

This disclosure relates to methods and system for allocating charging resources to a plurality of electric vehicles. In particular to such methods and systems, wherein a connection configuration is determined for at least one electric vehicle. This disclosure further relates to a control system, a computer program and a storage medium for such methods and/or systems.

### BACKGROUND

Electric vehicles are becoming more and more omnipresent. Of course, all these electric vehicles need to be charged regularly. The charging of ever more electric vehicles is expected to put a significant strain on the existing charging infrastructures and power distribution systems. To illustrate, typically, a maximum capacity of charging resources, e.g. amperes, is defined for a group of EVSEs. Such group of EVSEs may also be referred to as a capacity group and is for example formed by EVSEs that are present in a parking lot. The maximum capacity may then define that, at any given time, not more than the maximum capacity can be provided in total to the electric vehicles that are charging with the capacity group.

If many electric vehicles are charging in the capacity group, it may be that the charging resources that they, together, request, exceeds the maximum capacity. For this situation, charging resource allocation schemes may be employed that allocate the charging resources to the electric vehicles. As a result, at least some electric vehicles will receive less charging resources than they request. Such allocation schemes may for example be based on a state of the charge of the respective batteries of the electric vehicles, e.g. in the sense that electric vehicles having batteries with low state of charge are allocated charging resources as requested whereas the electric vehicles having batteries with high state of charge are allocated limited, or no, charging resources.

Of course, it is undesirable that electric vehicles receive less charging resources than requested. Hence, there is a need in the art for a method and system for allocating charging resources which enables to efficiently use the total capacity of a charging system.

### SUMMARY

To that end, a method is disclosed for allocating charging resources to a plurality of electric vehicles. The electric vehicles are connected to a polyphase power distribution system for receiving said charging resources. The method comprises determining a first connection configuration for a first electric vehicle out of the plurality of electric vehicles by determining that the first electric vehicle is connected to a first subset of one or more phases of the polyphase power distribution system and not connected to a second subset of one or more phases of the polyphase power distribution system. The method also comprises, based on the determined first connection configuration, allocating charging resources to the electric vehicles.

The inventors have realized that there are electric vehicles that can only connect to a subset of phases of the power distribution system. To illustrate, there are electric vehicles that connect to only one phase of a three-phase power distribution system. Such an electric vehicle then typically uses a one-phase charging cable that, when it is plugged into an EVSE of the power distribution system, is connected to only one phase of the power distribution system. To which phase of the power distribution system the electric vehicle connects may depend on the orientation with which a plug of the charging cable is inserted into a socket of the EVSE and/or may depend on how the EVSE is connected to the power distribution system, i.e. to which phases of the power distribution system the respective (female) connectors of the EVSE's socket are connected. It is best practice to, when installing EVSEs of a charging system, vary how the EVSEs are connected to the different phases of the power distribution system. This decreases the probability that several one-phase charging electric vehicles are all connected to the same phase of the power distribution system. This would result in an uneven load on the phases of the power distribution system, i.e. a high load on one phase of the power distribution system and low loads on the other phases of the power distribution system.

An amount of charging resources may be understood to refer to an amount of electrical energy and/or amount of electrical power and/or amount of amperes.

A connection configuration for an electric vehicle as used herein may be understood to refer to how the electric vehicle is connected to the power distribution system, i.e. to which phases of the power distribution system the electric vehicle is connected. Typically, the connection configuration for a connected electric vehicle is unknown. A control system of an EVSE for example typically does not know whether an electric vehicle is only connected to a subset of phases, let alone to which subset of phases the electric vehicle would be connected. The inventors have realized that this is disadvantageous and limits the efficiency with which the total capacity of the charging system is used.

To illustrate, if the connection configuration for a single-phase-charging electric vehicle is unknown, then, for safety reasons, it has to be assumed during the allocation of charging resources that the electric vehicle is connected to all phases. This limits the efficiency of capacity usage as illustrated by the following. In an example situation, the polyphase power distribution system is a three-phase system each phase of which can at most provide 50 amperes to charging electric vehicles. At some point in time, the used capacity for phase 1 is 50 amperes, the used capacity for phase 2 is 32 amperes and for phase 3 also 32 amperes. If a single-phase-charging electric vehicle requests to receive an (additional) 16 amperes and its connection configuration is unknown, the request cannot be granted. After all, the electric vehicle may be connected to phase 1 and allocating an (additional) 16 amperes to it would cause the amount of provided charging resources via phase 1 to exceed its total capacity of 50 amperes, which is unsafe and which would typically cause a breakdown of the system. On the other hand, if it would be known that the electric vehicle is connected to phase 2 only, then the request can be granted. After all, this would only increase the amount of charging resources provided via phase 2 to 48 amperes, which is lower than its maximum of 50 amperes. This example illustrates that knowledge of the connection configuration improves the efficiency with which the total charging capacity is used. If the connection configuration is unknown, 36 amperes of remaining capacity is unused, whereas if the connection configuration is known, only 20 amperes of remaining capacity is unused.

In light of the above, it is clear that, as referred to in this disclosure, determining a connection configuration is not to be understood as controlling a connection configuration nor as causing a connection configuration to be in a particular way, but rather as discovering and/or deducing and/or finding out an unknown connection configuration. Any connection configuration referred to herein, e.g. the first connection configuration and/or the second connection configuration, is typically uncontrollable. If a connection configuration for an electric vehicle is uncontrollable it may be understood as that there are no controllable switches present suitable for controlling to which specific one or more phases of the polyphase power distribution system the electric vehicle in question is connected.

It should be appreciated that it is typically not possible to allocate resources to an electric vehicle per phase. For example, if an electric vehicle is connected to three phases, phase 1, phase 2, phase 3, and an X amount of charging resources is allocated to it, then X amount of charging resources is allocated via phase 1, X amount via phase 2 and X amount via phase 3. In such case, it is typically not possible to allocate different amounts via the different phases to the same electric vehicle.

The polyphase power distribution system may be a two-phase power distribution system, or a three-phase power distribution system. The polyphase power distribution system may comprise even more than three phases, such as four, five, et cetera. The polyphase power distribution system may be configured to distribute alternating current (AC) power. Optionally, the total power transfer across the phases is constant during each electric cycle. Polyphase systems may be understood to comprise a plurality of electrically conductive cables, one for each phase, for example.

An amount of charging resources may be understood to refer to an amount of electrical power and/or amount of amperes.

Determining the connection configuration may be performed based on a known installation design of the EVSE to which the first electric vehicle is connected and based on a known configuration of a plug of the electric vehicle's charging cable. Such plug configuration may depend on the type, e.g. brand, of electric vehicle.

Optionally, the method comprises determining one or more further connection configurations for one or more further electric vehicles out of the plurality of electric vehicles. In an example, the connection configuration of each electric vehicle out of the plurality of electric vehicles is determined. These connection configurations may be determined similarly as to how the first connection configuration may be determined as described herein. If the connection configuration for an electric vehicle cannot be determined with certainty, then this connection configuration may be determined to be a default connection configuration. As referred to herein, determining a default connection configuration for an electric vehicle may be understood as assuming that the electric vehicle is connected to a predetermined set of one or more phases of the polyphase power distribution system. For safety reasons, such default connection configuration is preferably that the electric vehicle is connected to all phases of the polyphase power distribution system. Preferably, charging resources are allocated based on all known connection configurations.

It should be appreciated that allocating charging resources to an electric vehicle may also be referred to as allocating charging resources to an electric vehicle supply equipment, EVSE, namely the EVSE to which the electric vehicle is connected.

The first and second subset together typically comprise all phases of the power distribution system.

In an embodiment, allocating the charging resources to the plurality of electric vehicles comprises determining for each electric vehicle a maximum amount of charging resources that will be provided to the EVSE. As such, allocating charging resources to an electric vehicle may be understood as assigning a certain capacity that may or may not be fully used.

In an embodiment, the method comprises causing charging resources to be provided to the electric vehicles in accordance with the allocated charging resources.

Providing charging resources to an electric vehicle in accordance with allocated charging resources to this electric vehicle may be understood to comprise providing the charging resources to the electric vehicle such that the provided charging resources do not exceed the allocated charging resources. The allocated charging resources for an EVSE may be understood to define a maximum amount of charging resources that the EVSE is allowed to provide to the electric vehicle charging with it.

In an example, the determined maximum amount of charging resources is transmitted to the electric vehicle and/or to the EVSE to which the electric vehicle is connected as part of a charging profile. The electric vehicle and/or EVSE may comprise a controller that is configured to keep the charging resources, e.g. the charge current, that are actually provided to the electric vehicle below the maximum amount of charging resources, for example as defined in such charging profile.

In an embodiment, the polyphase power distribution system has N number of phases, N being higher than one. In this embodiment, the method comprises, for each phase of the power distribution system, determining a total amount of charging resources that it provides to said electric vehicles. This embodiment further comprises, for each electric vehicle out of said electric vehicles, determining N values. Each value indicates an amount of charging resources provided to the electric vehicle in question via an unspecified phase of the power distribution system. This embodiment, also comprises, based on said determined total amounts for the respective phases of the power distribution system and based on said determined values for the electric vehicles, determining the first connection configuration.

This embodiment allows to accurately determine the first connection configuration without requiring information about the plug configuration or the configuration of the electric vehicle's EVSE.

Any connection configuration may be determined in this manner. Typically N is two or three.

Determining N values may comprise measuring the N values and/or receiving the N values from a meter. Typically, each EVSE comprises a local meter for measuring the N values in the sense that this meter measures the amount of charging resources that are provided via each phase to the electric vehicle that is connected to the EVSE. Of course, each value is associated with some phase. However, the phases as used by the meter and EVSE do not correspond in a predictable manner to phases of the power distribution system. It could very well be that a first phase of the power distribution system is called “phase 1” by one meter/EVSE and that the first phase of the power distribution system is called “phase 2” by another meter/EVSE. In fact, typically this is the case as it is best practice to vary the way EVSEs are connected to the power distribution system.

Each value of the N values preferably indicates the amount of charging resources for a different phase of the power distribution system.

In an embodiment, the method comprises, at a first time at which the first electric vehicle is not charging, determining, for each phase of the power distribution system, a total amount of charging resources that it provides to said electric vehicles. Herewith, {P_{1,T1}; P_{2,T1}; . . . ; P_{N,T1}} is obtained, wherein P_{k,T1}, indicates the total amount of resources provided to the electric vehicles via the k^{th} phase at the first time, k being an integer between 1 and N. Then, this embodiment comprises, at a second time at which the first electric vehicle is charging, determining again, for each phase of the power distribution system, a total amount of charging resources that it provides to said electric vehicles. Herewith, {P_{1,T2}; P_{2,T2}; . . . ; P_{N,T2}} is obtained, wherein P_{k,T2}, indicates the total amount of resources provided to the electric vehicles via the k^{th} phase at the second time. This embodiment also comprises determining said N values for the first electric vehicle. Herein, one value of the N values indicates that a nonzero amount of charging resources is provided to the first electric vehicle via an unspecified phase and the other one or more values of the N values each indicate that zero charging resources are provided via an unspecified phase to the first electric vehicle. This embodiment also comprises determining a difference {δ₁; δ₂; . . . ; δ_{N}} between {P_{1,T1}; P_{2,T1}; . . . ; P_{N,T1}} and {P_{1,T2}; P_{2,T2}; . . . ; P_{N,T2}}. Then, the embodiment comprises determining that δ₁ has approximately the same value as said nonzero amount and that each of {δ₂; . . . ; δ_{N}} are approximately zero. Then, this embodiment comprises, based on this determination, determining the first connection configuration to be that the electric vehicle is connected to the first phase of the power distribution system and not connected to any of the other phases of the power distribution system.

This embodiment provides an accurate manner for determining the first connection configuration. If one electric vehicle starts a charging session between the first and second time, and it is known that on only one, unspecified phase the electric vehicle receives x amount of charging resources, then it can be derived to which phase the electric vehicle is connected if said difference array has only one nonzero value being x.

The difference may be understood to be a difference vector and may be given by {δ₁; δ₂; . . . ; δ_{N}}={P_{1,T2}−P_{1,T1}; P_{2,T2}−P_{2,T1}; . . . ; P_{N,T2}−P_{N,T1}}.

δ₁ having approximately the same value as said nonzero amount may be understood as that the difference between them is smaller than some threshold amount. This threshold is for example 2.5 ampere.

Further, approximately zero charging resources being provided may be understood as that less than 2.5 amperes are provided.

The second time may be one minute later than the first time. In an embodiment the method comprises repeatedly determining, for each phase of the power distribution system, a total amount of charging resources that it provides to said electric vehicles and repeatedly determining said N values for the first electric vehicle, optionally for all electric vehicles, for example every minute or every two minutes.

The N values for the first electric vehicle are determined, e.g. measured, when the first electric vehicle is charging. Preferably, the N values are determined, e.g. measured, close to the second time, e.g. shortly before or after the second time, or at the second time.

In an embodiment, the method comprises, at a first time at which the first electric vehicle is not charging, determining, for each phase of the power distribution system a total amount of charging resources that it provides to said electric vehicles thus obtaining {P_{1,T1}; P_{2,T1}; . . . ; P_{N,T1}}, P_{k,T1} indicates the total amount of resources provided to the electric vehicles via the k^{th} phase at the first time, k being an integer between 1 and N. This embodiment also comprises, at a second time at which the first electric vehicle is charging, determining again, for each phase of the power distribution system a total amount of charging resources that it provides to said electric vehicles thus obtaining {P_{1,T2}; P_{2,T2}; . . . ; P_{N,T2}}. P_{k,T2}, indicates the total amount of resources provided to the electric vehicles via the k^{th} phase at the second time. This embodiment further comprises measuring said N values for the first electric vehicle, wherein one value of the N values indicates a nonzero amount of charging resources being provided to the first electric vehicle via an unspecified phase and the other one or more values of the N values indicates or each indicate zero charging resources being provided via an unspecified phase to the first electric vehicle. Then, the method comprises, based on {P_{1,T1}; P_{2,T1}; . . . ; P_{N,T1}} and/or on {P_{1,T2}; P_{2,T2}; . . . ; P_{N,T2}}, determining for each phase of the power distribution system, an amount of charging resources {P′₁; P′₂; . . . ; P′_{N}} by taking into account that one or more electric vehicles, having known connection configurations, are provided less or more charging resources at the second time than at the first time. This may be for example performed in accordance with {P′₁; P′₂; . . . ; P′_{N}}={P_{1,T2}; P_{2,T2}; . . . ; P_{N,T2}}−{EV₁, EV₂; . . . ; EV_{N}},_{change}. Herein EV_{k,change} indicates, for electric vehicles having known connection configurations, a total difference between (i) the amount of charging resources provided via the k^{th} phase at the first time to electric vehicles having known connection configurations and (ii) the amount of charging resources provided via the k^{th} phase at the second time to the electric vehicles having known connection configurations. To illustrate, it may be that some electric vehicles start charging between the first and second time instance and that other electric vehicles stop charging between the first and second time instance. If the connection configuration of these vehicles is known, at least at the second time, then part of the difference between {P_{1,T1}; P_{2,T1}; . . . ; P_{N,T1}} and {P_{1,T2}; P_{2,T2}; . . . ; P_{N,T2}} can be accounted for. It should be appreciated any change in provided charging resources for an electric vehicle can be accounted for in such manner. It may for example be that an electric vehicle consumes less charging resources at the second time instance than at the first time instance, because its battery is almost fully charged. Such reduction (or increase) may also account for the difference between {P_{1,T1}; P_{2,T1}; . . . ; P_{N,T1}} and {P_{1,T2}; P_{2,T2}; . . . ; P_{N,T2}}. This embodiment further comprises determining a difference {δ₁; δ₂; . . . ; δ_{N}} between (i) {P_{1,T1}; P_{2,T1}; . . . ; P_{N,T1}} or {P_{1,T2}; P_{2,T2}; . . . ; P_{N,T2}} and (ii) {P′₁; P′₂; . . . ; P′_{N}} and determining that δ₁ has approximately the same value as said nonzero amount and that each of {δ₂; . . . ; δ_{N}} are approximately zero. This embodiment then comprises, based on this determination, determining the first connection configuration to be that the electric vehicle is connected to the first phase of the power distribution system and not connected to any of the other phases of the power distribution system.

{P′₁; P′₂; . . . ; P′_{N}} may be determined in accordance with {P′₁; P′₂; . . . ; P′_{N}}={P_{1,T2}; P_{2,T2}; . . . ; P_{N,T2}}−{EV₁; EV₂; . . . ; EV_{N}},_{change} wherein EV_{k,change} indicates a total difference between (i) the amount of charging resources provided via the k^{th} phase at the first time to electric vehicles having known connection configurations, and (ii) the amount of charging resources provided via the k^{th} phase at the second time to the electric vehicles having known connection configurations. In such case, the difference is preferably determined between (i) {P_{1,T1}; P_{2,T1}; . . . ; P_{N,T1}} and (ii) {P′₁; P′₂; . . . ; P′_{N}}.

{P′₁; P′₂; . . . ; P′_{N}} may be determined in accordance with {P′₁; P′₂; . . . ; P′_{N}}={P_{1,T1}; P_{2,T1}; . . . ; P_{N,T1}}+{EV₁, EV₂; . . . ; EV_{N}},_{change} wherein EV_{k,change} indicates a total difference between (i) the amount of charging resources provided via the k^{th} phase at the first time to electric vehicles having known connection configurations, and (ii) the amount of charging resources provided via the k^{th} phase at the second time to the electric vehicles having known connection configurations. In such case, the difference is preferably determined between (i) {P_{1,T2}; P_{2,T2}; . . . ; P_{N,T2}} and (ii) {P′₁; P′₂; . . . ; P′_{N}}.

This embodiment enables to determine the first connection configuration even if other electric vehicles end and/or start a charging session between the first and second time and even if electric vehicles consume more or less charging resources at the second time than at the first time.

The second time is for example 1 minute later than the first time. An amount of charging resources being substantially zero or approximately zero may be understood to refer to the amount of charging resources being smaller than a predetermined amount, e.g. smaller than 1 A. Further, two values being approximately different may be understood as that their difference is smaller than a predetermined amount, e.g. smaller than 1 A. Such predetermined amount may be a predetermined percentage, such as 15%, of the largest value out of the N values referred to above. To illustrate, if for some electric vehicle, the N values are: 15.5 A; 0.03 A and 0.03 A, then the predetermined value may be 2.33. In such case, the values 0.03 A may be regarded as approximately zero and any value between 13.175-17.825 A may be regarded as being approximately equal to 15.5 A.

In an embodiment, allocating the charging resources to the electric vehicles comprises determining that each phase in the first subset of phases of the power distribution system has a respective unallocated capacity of charging resources. Herein, each respective unallocated capacity is equal to or higher than a first amount of charging resources. This embodiment comprises, based on this determination, allocating the first amount of charging resources to the first electric vehicle.

This embodiment advantageously identifies that there is unallocated capacity on each of the phases to which the first electric vehicle is connected. Hence, safely more charging resources can be allocated to the first electric vehicle without the risk of exceeding capacity on one of the phases in the first subset.

Determining that each phase in the first subset has a respective unallocated capacity may be performed based on actually provided total charging resources via each phase and/or based on total allocated charging resources via each phase.

The first amount may be an additional amount, in addition to charging resources already provided to the first electric vehicle. Allocating the first amount may thus be performed by increasing the allocated amount to the first electric vehicle by said first amount.

In this embodiment, optionally, at least one phase of the phases in the second subset may not have unallocated capacity of charging resources or may have unallocated capacity of charging resources that is lower than said first amount of charging resources. This embodiment is especially advantageous in situations wherein one of the phases in the second subset is used to full capacity. In such case, were it not for the methods disclosed herein, no additional charging resources would be allocated to the first electric vehicle.

In an embodiment, determining that each phase in the first subset of phases has a respective unallocated capacity of charging resources comprises a number of steps. One step is, for each phase of the power distribution system, determining a total amount of allocated charging resources via the phase in question. This step comprises summing respective allocated amounts of charging resources, which respective amounts are allocated to respective electric vehicles via the phase in question. Another step comprises comparing each determined total amount of allocated charging resources of a respective phase with a respective total capacity associated with each respective phase.

This embodiment is advantageous in that the amount of allocated charging resources per phase is determined. Preferably, a connection configuration is determined for each electric vehicle, optionally a default connection configuration, so that the allocated charging resources per phase can be accurately determined.

Typically each phase of the power distribution system has the same total capacity. Said comparing may comprise subtracting each determined total amount of allocated charging resources of a respective phase from a respective total capacity for that phase. Then, an unallocated amount of charging resources per phase may be obtained, which allows to determine whether all phases in the second subset of phases has at least a first amount of unallocated capacity.

In an embodiment, the method comprises determining a second connection configuration for a second electric vehicle out of the plurality of electric vehicles by determining that the second electric vehicle is connected to a third subset of one or more phases of the polyphase power distribution system and not connected to a fourth subset of one or more phases of the polyphase power distribution system. Herein, said first subset of one or more phases comprises a first phase of the power distribution system. The second subset of one or more phases comprises a second phase of the power distribution system. The third subset comprises the second phase and the fourth subset comprises first phase. This embodiment also comprises, based on determined first connection configuration and second connection configuration, allocating charging resources to the second electrical vehicle.

This embodiment allows to charge two electric vehicles connected to different phases in a manner that efficiently utilizes the total capacity of the charging system.

The charging resources allocated to the second electric vehicle may be additional charging resources, in addition to charging resources already allocated to it.

The first subset and third subset of one or more phases of the power distribution system preferably have no phase in common,

In an embodiment, the method comprises, before determining the first connection configuration, allocating a certain amount of charging resources to the first electric vehicle. Thereafter, for each phase of the power distribution system, a total amount of allocated charging resources via the phase in question is determined. This step comprises summing respective allocated amounts of charging resources, which respective amounts are allocated to respective electric vehicles via the phase in question. Herein, each determined total amount of allocated charging resources determined for each phase of the power distribution system contains said certain amount. This embodiment comprises, thereafter, based on determining the first connection configuration, reducing, for each phase that is in the second subset, its determined total amount of allocated charging resources by said certain amount.

When an electric vehicle starts charging its connection configuration may be unknown, meaning that, for safety reasons explained herein, the charging resources allocated to it should be counted for every phase, when determining the total amount of allocated resources per phase. However, when it is known how the electric vehicle is connected to the power distribution system, this is no longer necessary. Only for the phases to which the electric vehicle is actually connected should the resources allocated to the electric vehicle be counted for the total amount of allocated resources. Hence, in this embodiment capacity on the phases to which the electric vehicle is not connected, is freed up again.

In an embodiment, the method comprises, after reducing each total amount of allocated charging resources for each phase in the second subset by said certain amount, determining that each phase in said third subset of phases of the power distribution system has a respective unallocated capacity of charging resources. Herein, each respective unallocated capacity is equal to or higher than a second amount of charging resources. This embodiment comprises, based on this determination, allocating the second amount of charging resources to the second electric vehicle.

In this embodiment, the capacity that is freed up on the phases due to the determination of the first connection configuration may be at least partially be allocated to the second electric vehicle.

One aspect of this disclosure relates to a system for allocating charging resources to a plurality of electric vehicles connected to a polyphase power distribution system for receiving said charging resources. The system comprises said polyphase power distribution system, and a plurality of electric vehicle EVSEs configured to connect to respective electric vehicles for charging the electric vehicles, and a control system that is configured to control an amount of charging resources, provided by each EVSE, to connected electric vehicles, wherein the control system is configured to perform any of the method for allocating charging resources described herein. The control system may also be referred to as a central control system. Apart from this, each EVSE may also comprise its own control system.

In an embodiment of the system, the polyphase power distribution system has N number of phases, N being higher than one. In this embodiment, the system comprises a main meter that is configured to measure, for each phase of the power distribution system, a total amount of charging resources that the phase in question provides to the plurality of electric vehicles, and a plurality of local meters associated with the respective plurality of electric vehicle EVSEs, each local meter being configured to measure, for its associated EVSE, N values, each value indicating an amount of charging resources provided to the EVSE in question via an unspecified phase of the power distribution system.

One aspect of this disclosure relates to a processor that is configured to perform any of the methods described herein.

One aspect of this disclosure relates to a computer program comprising instructions which, when the program is executed by a computer, cause the computer to carry out any of the methods described herein.

One aspect of this disclosure relates to a non-transitory computer-readable storage medium having stored thereon any of the computer programs described herein.

One aspect of this disclosure relates to a computer comprising a computer readable storage medium having computer readable program code embodied therewith, and a processor, preferably a microprocessor, coupled to the computer readable storage medium, wherein responsive to executing the computer readable program code, the processor is configured to perform any of the methods described herein.

One aspect of this disclosure relates to a computer program or suite of computer programs comprising at least one software code portion or a computer program product storing at least one software code portion, the software code portion, when run on a computer system, being configured for executing any of the methods described herein.

One aspect of this disclosure relates to a non-transitory computer-readable storage medium storing at least one software code portion, the software code portion, when executed or processed by a computer, is configured to perform any of the methods described herein.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided. A computer program may, for example, be downloaded (updated) to the existing data processing systems (e.g. to the existing control system or be stored upon manufacturing of these systems.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 illustrates a system according to an embodiment for allocating charging resources to a plurality of electric vehicles;

FIG. 2 schematically illustrates an EVSE comprising a local meter according to an embodiment;

FIG. 3 shows two diagrams illustrating total allocated charging resources via respective phases of the power distribution system, which diagrams illustrate the allocation of charging resources to a single-phase charging vehicle, according to an embodiment;

FIG. 4 shows three diagrams illustrating total allocated charging resources via respective phases of the power distribution system, which diagrams illustrate how charging capacity is freed up for some phases upon the determination of a connection configuration, according to an embodiment;

FIG. 5 shows four diagrams illustrating total allocated charging resources via respective phases of the power distribution system, which diagrams illustrate how the determination of two connection configurations for two electric vehicles, according to an embodiment;

FIG. 6 schematically illustrates a data processing system according to an embodiment.

### DETAILED DESCRIPTION OF THE DRAWINGS

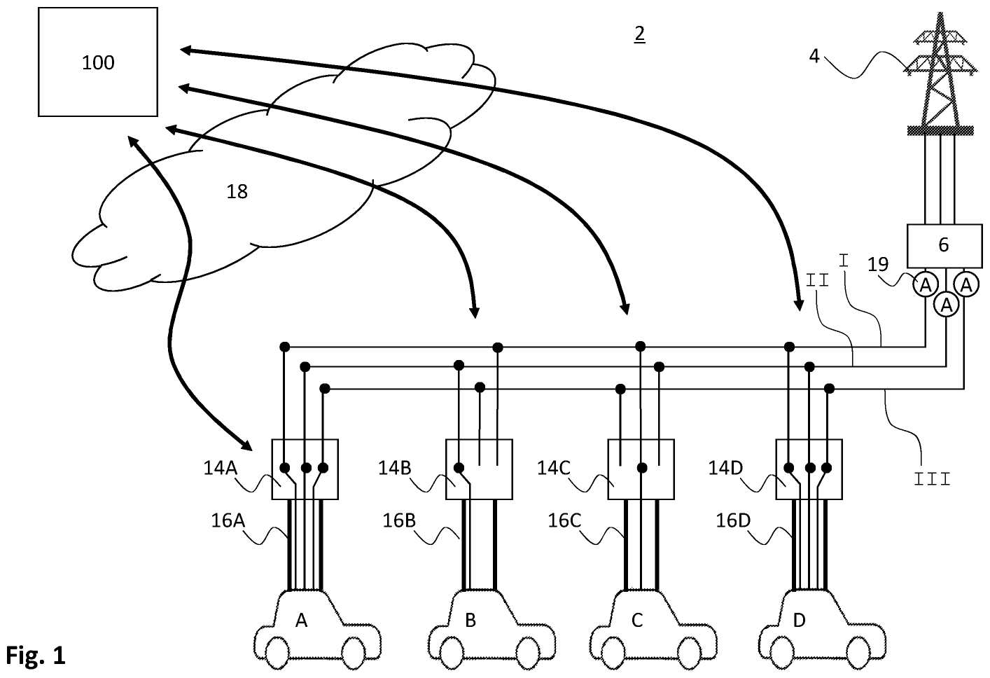

FIG. 1 illustrates a system 2 according to an embodiment for allocating charging resources to a plurality of electric vehicles, A, B, C, D that are connected to a polyphase power distribution system for receiving said charging resources. The polyphase power distribution system in FIG. 1 is schematically illustrated by the three phases I, II and III. These phases may be also be referred to as wires. In FIG. 1, the polyphase power distribution system receives its power from a power grid 4 via a converter 6. The power converter 6 is typically configured to convert the incoming power into a form that is suitable for the polyphase power distribution system. Power converter 6 may be configured to perform two conversion steps, one step for converting the high voltage one the power grids 4 to medium voltage and another step for converting medium voltage to low voltage.

The system 2 comprises the power distribution system and a plurality of electric vehicle supply equipments, EVSEs, 14 configured to connect to respective electric vehicles A, B, C, D for charging the electric vehicles. As used herein, electric vehicle may be understood to relate to any vehicle comprising an electric propulsion motor. Non-limiting examples of electric vehicles are electric cars, electric motorcycles, electric bicycles, electric airplanes and electric ships. An electric propulsion motor converts electrical energy into mechanical energy and therefore an electric vehicle comprises one or more batteries for storing electrical energy. The electric vehicles and EVSEs are configured to electrically connect to each other in order to charge the one or more batteries of the electric vehicles.

The system 2 further comprises a control system 100, which may also be referred to as data processing system 100, that is configured to control an amount of charging resources that can be provided by each EVSE to connected electric vehicles. The control system 100 may be configured to control the amount of charging resources that an EVSE provides by sending to the EVSE a so-called charging profile. Such charging profile then defines a maximum amount that the EVSE in question may provide to its electric vehicle. It should be appreciated that the electric vehicle does not necessarily consume this maximum amount. It may very well be that the electric vehicle consumes an amount of charging resources that is lower than said maximum amount. The electric vehicles may not consume an amount of charging resources that is higher than said amount. If the electric vehicle consumes an amount of charging resources that is higher than said amount, then the EVSE may stop the charge session. Note that such a situation will in general not occur.

An EVSE may control the amount of charging resources that it provides to an electric vehicle connected to it by communicating to the electric vehicle the maximum amount of charging resources that the electric vehicle may draw from the EVSE, for example in accordance with the methods as described in the IEC61851 standard and/or in the SAE-J1772 standard. Typically, the electric vehicle can control how much charging resources it consumes. The EVSE may subsequently measure the charging resources that it provides to the electric vehicle, for example using an amperemeter. If the (control system of) the EVSE determines that more charging resources are being provided to the electric vehicle than the communicated maximum amount, the EVSE may be configured to disconnect the electric vehicle from the charging system, e.g. by actuating a power switch.

Such communication between control system of EVSE and electric vehicle may takes place over a specific electrical wire (also referred to as the ‘Communication Pilot’) that may be part of the charging cable with which the electric vehicle is connected to the EVSE.

A charging profile may define a maximum amount of to be provided charging resources for an EVSE, wherein the maximum amount varies with time. The charging profile for an EVSE may for example define a first time slot wherein the maximum amount is substantially zero. As a consequence the electric vehicle charging with the EVSE in question will not receive any charging resources during the first time slot. These varying maximum amounts that may be defined by respective charging profiles enable to allocate charging resources among many electric vehicles in a fair manner without risking exceeding a total capacity that the power distribution system can handle.

A plurality of EVSEs may form a capacity group. For such a capacity group a capacity group maximum amount of charging resources is defined. The total amount of charging resources that is provided to the capacity group as a whole should never exceed that capacity group maximum amount. Typically, this would result in a failure of the system. Such a failure may involve a circuit breaker tripping. It should be appreciated that the capacity group maximum amount may also vary with time.

In FIG. 1, the control system is shown as a remote system that is connected to the respective EVSEs 14 through a network 18 such as the internet. However, it should be appreciated that the control system may be arranged locally with the EVSEs 14 as well. In an example, the control system 100 is a distributed system in that several of its elements are implemented at various locations, for example in the sense that it has elements implemented at various EVSEs. The connection between an EVSE 14 and control system 100 may be at least partially wireless.

The control system 100 is configured to perform any of the methods described herein for allocating charging resources to respective electric vehicles charging with respective EVSEs.

In FIG. 1, the polyphase power distribution system has three phases, indicated by I, II and III. In an embodiment, the system 2 comprises a main meter 19 that is configured to measure, for each phase of the power distribution system, a total amount of charging resources that the phase in question provides to the plurality of electric vehicles A, B, C, D. The main meter 19 in FIG. 1 is embodied as a system comprising three ampere meters, one amp meter for each phase. The main meter is preferably configured to perform said measurements repeatedly, e.g. periodically, for example once per minute.

FIG. 1 further shows that the electric vehicles are connected to the polyphase power distribution system via an EVSE 14. In the depicted example, each electric vehicle is connected to an EVSE by means of cable 16. As shown, cables 16A and 16D comprise three wires and are three-phase power cables. However, cables 16B and 16C each only comprise one wire and are one-phase cables. Apparently, electric vehicles B and C charge their batteries using only a single phase. FIG. 1 further shows that the way that each EVSE 14 is connected to the power distribution system may vary.

Electric vehicle A is connected to all three phases I, II, III of the power distribution system. Electric vehicle D is connected to all three phases as well. However, electric vehicle B is only connected to phase II of the polyphase power distribution system and not to phase I and not to phase II. Electric vehicle C is only connected to phase I of the power distribution system, and not to phase II and not to phase III.

In an embodiment, the method comprises determining the connection configuration for electric vehicle B by determining that it is connected to phase II and not to phases I and III. In such case, the first subset of phases referred to herein consists of phase II and the second subset of phases consists of phases I and III. Then, based on the determined connection configuration, the control system 100 can allocate charging resources to the electric vehicles A, B, C, D. Because, the connection configuration has been determined, such allocation can then be performed in a manner that more efficiently utilizes available charging resources.

Unfortunately, it is typically not always administrated, at least not in a reliable manner, how each EVSE 14 is connected to the polyphase power distribution system nor how a single phase EVSE, such as B and C, connects to an EVSE.

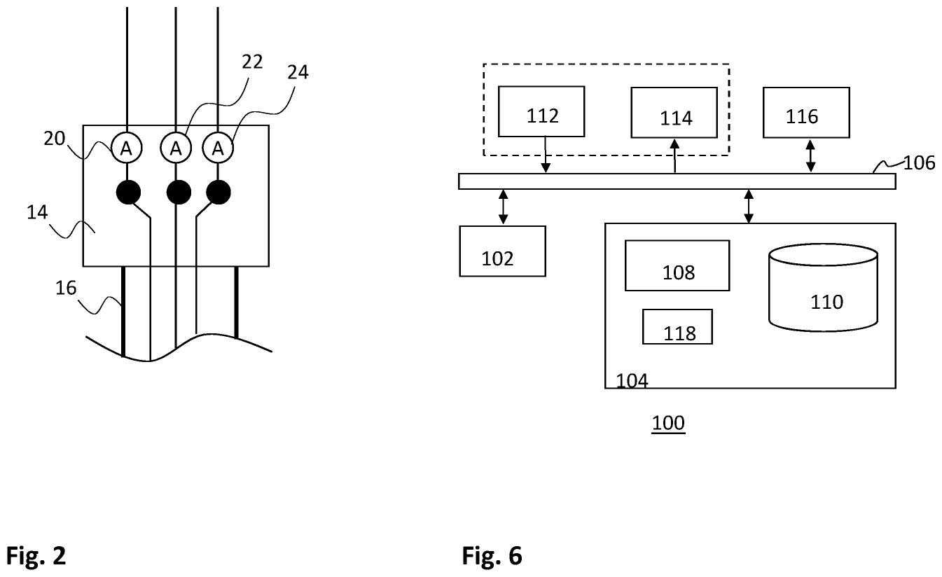

FIG. 2 schematically illustrates a detailed example an EVSE that may be used in an embodiment that enables to determine the connection configuration of electric vehicles. In such embodiment, the system 2 comprises a plurality of local meters associated with the respective plurality of electric vehicle EVSEs. Each local meter is configured to measure, for its associated EVSE, N values, each value indicating an amount of charging resources provided to the EVSE in question via an unspecified phase of the power distribution system. Preferably, such a local meter is configured to perform said measurements repeatedly, e.g. periodically, such as once every minute. The EVSE 14 that is shown in FIG. 2 comprises such a local meter. This local meter comprises three ampere meters 20, 22, 24. However, it is typically not known for which phase amp meter 20 measures the provided charging resources, and not known for which phase amp meter 22 measures the provided charging resources, and not known for which phase amp meter 24 measures the provided charging resources. To illustrate, if the EVSE of FIG. 2 would be implemented as EVSE 14A in FIG. 1, then amp meter 20 would measure the provided charging resources via phase I of the power distribution system, whereas if the EVSE of FIG. 2 would be implemented as EVSE 14B in figure, then amp meter 20 would measure the provided charging resources via phase II.

Thus, the local meter of FIG. 2 measures three values, wherein each value indicates an amount of charging resources provided via an unspecified phase to the electric vehicles that is charging with the EVSE 14 of FIG. 2. If, for example using main meter 19, the total amount of provided charging resources is measured per phase, then, based on said determined total amounts for the respective phases of the power distribution system and based on said determined values for the electric vehicles, the connection configuration can be determined.

To illustrate, the connection configuration can be determined as follows. Assume that for phase I, the total amount of charging resources that it provides to the electric vehicles, for example as measured by main meter 19, is 100 A, and for phase II this is 75 A and for phase III this is also 75 A. Further, the three values for the vehicle A, B, C, D are as follows, each value indicating an amount of charging resources provided to the electric vehicle via an unspecified phase. (These values may be provided by local meters described herein.)
A: 25 A; 25 A; 25 A
B: 0; 0; 25 A
C: 25 A; 25 A; 25 A
D: 25 A; 25 A; 25 A

Then, based on these values and based on the total amounts for the respective phases (100 A for phase 1, 75 A for phase 2, 75 A for phase 3), it can be concluded that electric vehicle B is only connected to phase I. B namely consumes 25 A via only one phase as is clear from the three values (0;0;25) and from the total amounts of charging resources provided per phase it is clear that this 25 A is provided via phase I. Note that this examples deviates from the example shown in FIG. 1 in that electric vehicle C in this example is connected to all three phases, whereas in FIG. 1, EV C is connected only to phase I.

It should be appreciated that this is a simple example. However, the same principle can be easily applied to more complex examples. A skilled person who is provided with the values for each electric vehicle (e.g. as measured by local meters as described herein) and with the total amount of charging resources provided per phase (e.g. as measured by a main meter as described herein) would have no problem to determine the connection configurations, if, of course, these indeed can be determined based on the provided information.

It is typically not possible to allocate charging resources to an electric vehicle per phase. It is for example not possible to allocate x amount to phase I for an electric vehicle, y amount to phase II for the electric vehicle and z amount to phase III for the electric vehicle. One reason that this is typically not possible is that neither the EVSE nor the electric vehicle typically knows to which phase or which phases of the power distribution it is connected. When in this disclosure an amount of charging resources is said to be allocated to an electric vehicle, then typically this means that this amount of charging resources is allocated to each phase. If for example 25A are said to be allocated to an electric vehicle, then typically, the EVSE to which this electric vehicle is connected will ensure that on none of its phases it provides more than 25 A to the electric vehicle. In such case, typically, it will at most provide 25 A at each of the phases.

The following tables illustrate how a connection configuration can be determined according to an embodiment.

Table I indicates for each phase the total amounts of charging resources that it provides to the electric vehicles, at two respective time instances T1 and T2. These values may be measured by a main meter as described herein. Table I further indicates the differences per phase, between T1 and T2. Table II indicates for electric vehicle B three values, each value indicating the amount of charging resources provided via an unspecified phase. At T1, electric vehicle B is not charging yet, whereas at T2, electric vehicle B receives 12 A via only one phase.

Then, based on the 12 A in table I (in the δ column) and the 12 A in table II being equal, it can be determined that electric vehicle B is connected only to phase II.

TABLE I

| Phase | T1 (A) | T2 (A) | δ (A) |
|---|---|---|---|
| I | 100 | 100 | 0 |
| II | 100 | 112 | 12 |
| III | 95 | 95 | 0 |

TABLE II

| | T1 (A) | T2 (A) |
|---|---|---|
| Electric vehicle B | na | 12 |
| | na | 0 |
| | na | 0 |

The following tables illustrate how a connection configuration can be determined according to an embodiment. This embodiment enables to determine a connection configuration even if vehicles are leaving and/or starting a charge session between T1 and T2.

Table III indicates, for each phase, the total amounts of charging resources that it provides to the electric vehicles, at two respective time instances T1 and T2. These values may be measured by a main meter as described herein. Table III further indicates three corrections, one for electric vehicle A, one for electric vehicle C, one for electric vehicle D. These three corrections are then used to determine for each phase a further amount of charging resources. These further amounts are shown in column “T1′”. Electric vehicle C stops charging between T1 and T2. In this example, it is assumed that the connection configuration of electric vehicle C was known, i.e. that it was connected to phase I only, and it is assumed that it was consuming, at T1, 25 A. Further, electric vehicle D starts charging between T1 and T2. The configuration for electric vehicle D is also known, i.e. that it is connected to all three phases. Note that this can be determined relatively easy, e.g. by determining that the values for electric vehicle D as measured by local meters described herein are three equal values, which indicates that vehicle D is connected to all three phases. Preferably, the 10 A are provided to electric vehicles D at time T2. (At time T1 vehicle D was not yet charging.) Further, electric vehicle A, which is known to be connected to all three phases, is consuming less charging resources at T2 than at T1, namely 5 A less, for example because the battery of electric vehicle A is almost fully charged.

The column T1′ indicates a further amount of charging resources provided via each phase that takes into account that electric vehicle C left between time T1 and T2 and that electric vehicle D started between time T1 and T2 and that electric vehicle A is provided less charging resources at T2 than at T1. Effectively, each value in column T1′ is sum of the columns “T1”, “Correction for EV C leaving”, and “Correction for EVD starting”, and “Correction for EV A being provided less charging resources”: 85=105−25+10−5 and 110=105+0+10−5 and 105=100+0+10−5. Column “T1′” shows the array {P′₁; P′₂; . . . ; P′_{N}} referred to above, wherein {P′₁; P′₂; . . . ; P′_{N}} is determined based on {P_{1,T1}; P_{2,T1}; . . . ; P_{N,T1}} by taking into account that one or more electric vehicles, having known connection configurations, are provided less or more charging resources at T2 than at T1. Column “δ” indicates the difference between T1′ and T2, optionally in absolute values. Column “δ” may be understood to show the difference {δ₁; δ₂; . . . ; δ_{N}} between (i) {P_{1,T2}; P_{2,T2}; . . . ; P_{N,T2}} and (ii) {P′₁; P′₂; . . . ; P′_{N}}, referred to above.

Table IV indicates for electric vehicle B three values, each value indicating the amount of charging resources provided via an unspecified phase. At T1, electric vehicle B is not charging yet, whereas at T2, electric vehicle B receives 12 A via only one phase.

Then, based on the 12 A in table III (in the δ column) and the 12 A in table IV being equal, it can be determined that electric vehicle B is connected only to phase II and not to phase I and not to phase

TABLE III

| | | | | Correction for EV | | | |
|---|---|---|---|---|---|---|---|
| | | Correction | Correction | A consuming less | | | |
| | | for EV C | for EV D | charging | | | |
| Phase | T1 (A) | leaving | starting | resources | T1′ (A) | T2 (A) | δ (A) |
| I | 105 | −25 | 10 | −5 | 85 | 84 | 1 |
| II | 105 | 0 | 10 | −5 | 110 | 122 | 12 |
| III | 100 | 0 | 10 | −5 | 105 | 105 | 0 |

TABLE IV

| | T1 (A) | T2 (A) |
|---|---|---|
| Electric vehicle B | na | 12 |
| | na | 0 |
| | na | 0 |

Table V illustrates an alternative as to how the difference δ can be determined. Herein, column T2′ is determined based on T2 and the correction columns. T2′ may be understood to be the array {P′₁; P′₂; . . . ; P′_{N}} referred to in this disclosure, wherein in this case {P′₁; P′₂; . . . ; P′_{N}} is determined based on {P_{1,T2}; P_{2,T2}; . . . ; P_{N,T2}} by taking into account that one or more electric vehicles, having known connection configurations, are provided less or more charging resources at T2 than at T1. The values in column T2′ are the sum of the values in column T2 and the correction columns: 104=84+25−10+5; 117=122+0−10+5; 100=105+0−10+5. The differences in the δ column are then the differences between T1 and T2′, in absolute values: 1=104−105; 12=117−105; 0=100−100. In this embodiment, thus, the difference is determined between (i) {P_{1,T1}; P_{2,T1}; . . . ; P_{N,T1}} and (ii) {P′₁; P′₂; . . . ; P′_{N}}.

Similarly as before, based on the amount of charging resources of 12A that is provided to vehicle B at T2 being equal to the δ-value calculated for phase II, it can be determined that electric vehicle B is only connected to phase II.

TABLE V

| | | | | Correction for EV | | | |
|---|---|---|---|---|---|---|---|
| | | Correction | Correction | A being provided | | | |
| | | for EV C | for EV D | less charging | | | |
| Phase | T1 (A) | leaving | starting | resources | T2 (A) | T2′ (A) | δ (A) |
| I | 105 | 25 | −10 | 5 | 84 | 104 | 1 |
| II | 105 | 0 | −10 | 5 | 122 | 117 | 12 |
| III | 100 | 0 | −10 | 5 | 105 | 100 | 0 |

In the above examples, the values for electric vehicle B indicate how many charging resources are provided via unspecified phases at T2. Also table I, III and V indicate for each phase, the total amounts of charging resources that provided to the electric vehicles at T2. This enables accurate determination of the connection configuration. To this end, preferably, the local meters and the main meter described herein are synchronized in that they perform measurements at the same time. However, in practice there may be small deviations in that the local meters and main meter are not perfectly synchronized, i.e. do not perform measurements at exact the same times. In light of this, if in this disclosure charging resources are said to be provided at some time, then this may be understood as that the charging resources are provided within some predetermined time period comprising that time, e.g. in a time period ranging from 10 seconds before that time to 10 seconds after that time.

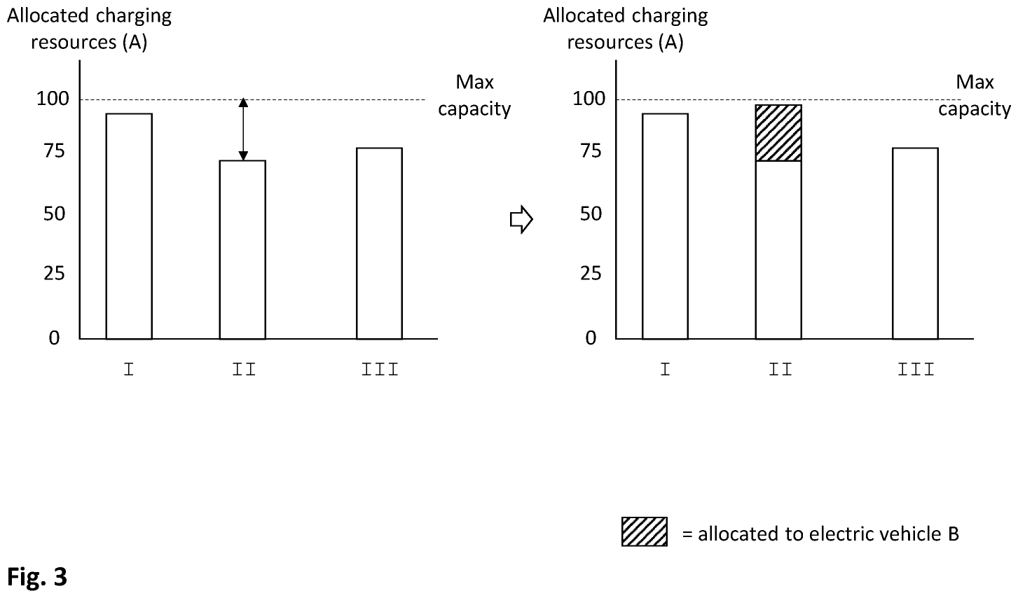

FIG. 3 shows two diagrams illustrating total allocated charging resources via respective phases of the power distribution system. These total allocated charging resources are the sum of charging resources already allocated to the respective electric vehicles. The diagrams illustrate how resources can be allocated to electric vehicles according to an embodiment. The dotted line in each diagram indicates the maximum amount of charging resources that can be provided to electric vehicles via the polyphase power distribution system.

Allocated amount of charging resources does not necessarily correspond to actually provided charging resources. Allocated charging resources to an electric vehicle may be understood to define a maximum amount of charging resources that can be provided to the electric vehicle. The electric vehicle does not necessarily consume all of its allocated charging resources.

In the depicted embodiment, it has been determined that electric vehicle B is connected to phase II and not connected to phase I and not connected to phase III. Such determination of the connection configuration may be performed in accordance with any of the methods described herein for determining the connection configuration.

In this embodiment, at some point in time as indicated in the left diagram, phase II of the power distribution system has an unallocated capacity of charging resources indicated by the double arrow. This is an example of a comparison of a determined total amount of allocated charging resources via phase II with a total capacity for phase II. Note that typically, each phase has the same total capacity. Since electric vehicle B is only connected to phase II, charging resources, equal to or less than the amount indicated by the double arrow, can be safely allocated to electric vehicle B as shown on the right hand side diagram. The allocation of charging resources to electric vehicle B cannot cause an increase of provided charging resources via phase I or phase III and therefore cannot cause the provided charging resources via phase I or III to exceed their maximum capacity.

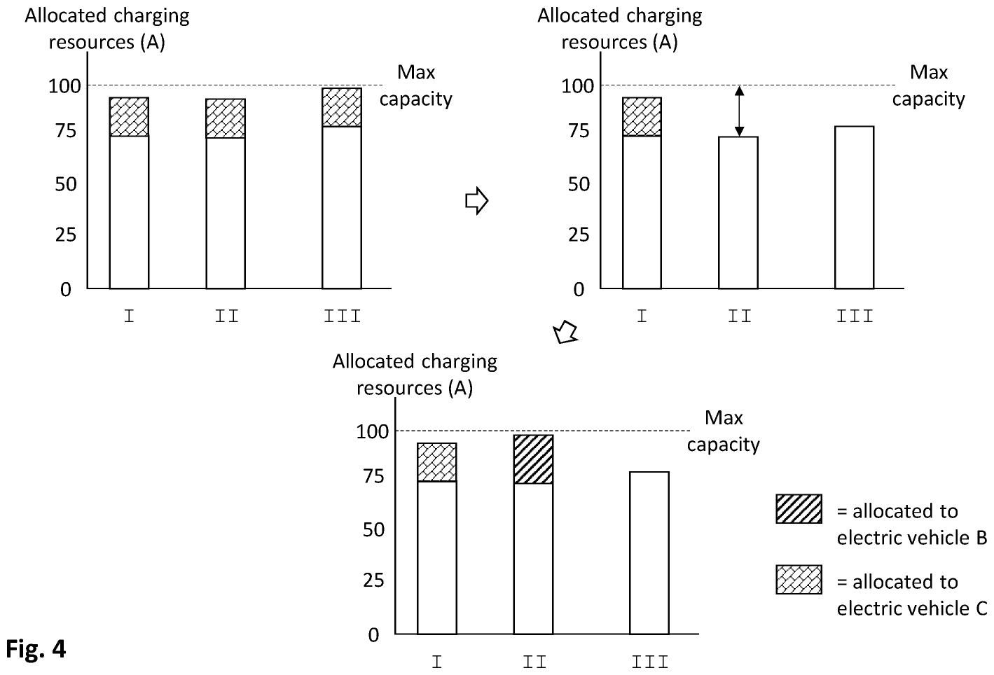

FIG. 4 again shows diagrams illustrating total allocated charging resources via respective phases of the polyphase power distribution system.

FIG. 4 illustrates an embodiment wherein first a certain amount of charging resources is allocated to electric vehicle C. Because the connection configuration of electric vehicle at that point in time is unknown, each total amount of allocated charging resources for each phase contains said certain amount as indicated in the top left diagram.

However, at some point in time, the connection configuration for electric vehicle may be determined to be that it is only connected to phase I. Then, for phases II and III, the total amount of allocated charging resources is reduced by said certain amount as shown in the top right diagram.

As a result, capacity is freed up for phases II and III. If for example the connection configuration for electric vehicle B has already been determined to be that electric vehicle B is connected only to phase II, and phase II has unallocated capacity of charging resources as indicated by the double arrow in the top right diagram, then an amount of charging resources, which may be an additional amount of charging resources in addition to the charging resources already allocated, can be allocated to electric vehicle B. This is shown in the bottom diagram.

This embodiment is an example where two electric vehicles are connected to different phases of power distribution system. In an embodiment, based on the determined difference connection configurations, charging resources can be allocated to both of them.

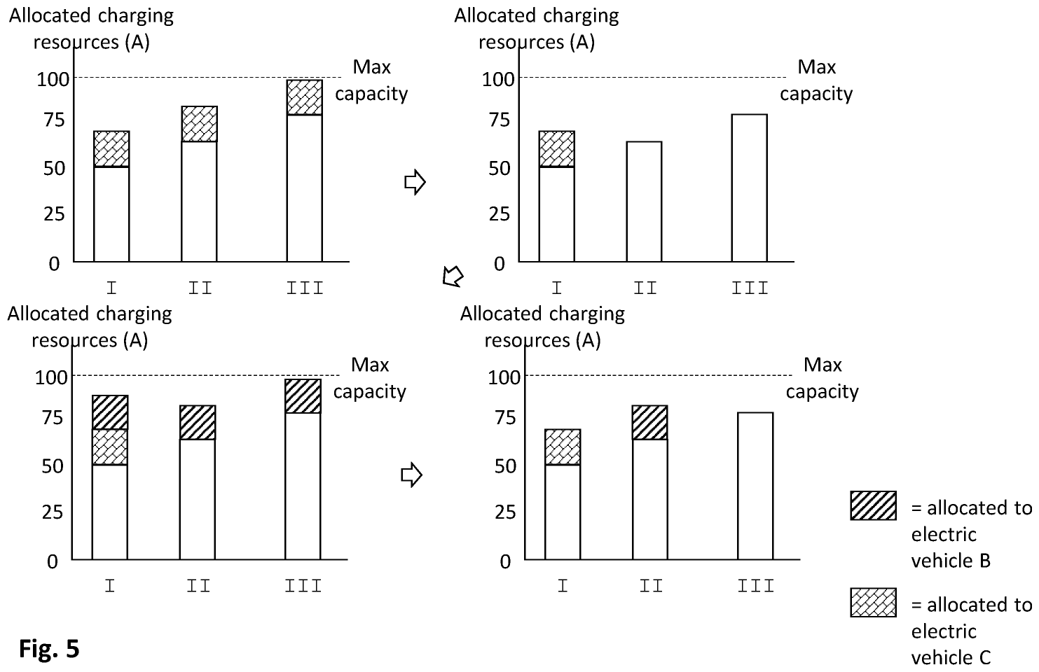

FIG. 5 illustrates allocation of charging resources according to an embodiment. FIG. 5 shows four diagrams illustrating total allocated charging capacity. The top left diagram illustrates that at some point in time charging resources are allocated to electric vehicle C, for example because electric vehicle C arrived at an EVSE and started a charging session. Then, the top right diagram illustrates that at some point in time, the connection configuration for electric vehicle has been determined. In this example, electric vehicle C is connected only to phase I of the power distribution system. This diagram illustrates that, as a result of this determination, capacity is freed up on phases II and III. Then, the diagram on the bottom left illustrates that now charging resources are allocated to electric vehicle B, for example because it has also arrived and has also started a charging session. Because the connection configuration for this vehicle is yet unknown, upon allocating charging resources to it, it is assumed that it is connected to all three phases. As stated before, charging resources can typically not be allocated per phase. It is for example typically not possible to instruct an EVSE to provide a certain amount of charging resources via a specific phase only. Typically, it is only possible to instruct an EVSE to provide at most a certain amount of charging resources without specifying phases. Then, the bottom right diagram illustrates that the connection configuration is determined for electric vehicle B as well. Electric vehicle B's connection configuration is that it is only connected to phase II. Hence, in the bottom right diagram, capacity is freed up on phases I and II relative to the bottom left diagram.

FIG. 6 depicts a block diagram illustrating a data processing system according to an embodiment.

As shown in FIG. 6, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

The memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a keyboard, a pointing device such as a mouse, a touch-sensitive display, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 6 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

As pictured in FIG. 6, the memory elements 104 may store an application 118. In various embodiments, the application 118 may be stored in the local memory 108, the one or more bulk storage devices 110, or apart from the local memory and the bulk storage devices. It should be appreciated that the data processing system 100 may further execute an operating system (not shown in FIG. 6) that can facilitate execution of the application 118. The application 118, being implemented in the form of executable program code, can be executed by the data processing system 100, e.g., by the processor 102. Responsive to executing the application, the data processing system 100 may be configured to perform one or more operations or method steps described herein.

In one aspect of the present invention, the data processing system 100 may represent a control system as described herein.

The data processing system 100 may represent a client data processing system. In that case, the application 118 may represent a client application that, when executed, configures the data processing system 100 to perform the various functions described herein with reference to a “client”. Examples of a client can include, but are not limited to, a personal computer, a portable computer, a mobile phone, or the like.

The data processing system 100 may represent a server. For example, the data processing system may represent an (HTTP) server, in which case the application 118, when executed, may configure the data processing system to perform (HTTP) server operations.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 102 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A method for allocating charging resources to a plurality of electric vehicles connected to a polyphase power distribution system for receiving said charging resources, the method comprising
determining an unknown first connection configuration for a first electric vehicle out of the plurality of electric vehicles by discovering that the first electric vehicle is connected to a first subset of one or more phases of the polyphase power distribution system and not connected to a second subset of one or more phases of the polyphase power distribution system, and
based on the determined first connection configuration, allocating charging resources to the electric vehicles.

2. The method according to claim 1, wherein the first connection configuration is not controllable.

3. The method according to claim 1, wherein the polyphase power distribution system has N number of phases, N being higher than one, the method comprising
for each phase of the power distribution system, determining a total amount of charging resources that the power distribution system provides to said electric vehicles, and
for each said electric vehicle of said electric vehicles, determining N values, each value indicating an amount of charging resources provided to that electric vehicle via an unspecified phase of the power distribution system,
based on said determined total amounts of charging resources for the respective phases of the power distribution system and based on said determined N values for the electric vehicles, deducing the first connection configuration.

4. The method according to claim 3, comprising
at a first time at which the first electric vehicle is not charging, determining, for each said phase of the power distribution system, a total amount of the charging resources that the power distribution system provides to said electric vehicles thus obtaining {P_{1,T1}; P_{2,T1}; . . . ; P_{N,T1}}, wherein P_{k,T1}, indicates the total amount of charging resources provided to the electric vehicles via a k^{th} phase at the first time, k being an integer between 1 and N, and then
at a second time at which the first electric vehicle is charging, determining again, for each said phase of the power distribution system, a total amount of charging resources that the power distribution system provides to said electric vehicles thus obtaining {P_{1,T2}; P_{2,T2}; . . . ; P_{N,T2}}, wherein P_{k,T2}, indicates the total amount of charging resources provided to the electric vehicles via the k^{th} phase at the second time,
determining said N values for the first electric vehicle, wherein one value of the N values indicates a nonzero amount of charging resources being provided to the first electric vehicle via an unspecified phase and the other one or more values of the N values each indicate approximately zero charging resources being provided via an unspecified phase to the first electric vehicle,
determining a difference {δ₁; δ₂; . . . ; δ_{N}} between {P_{1,T1}; P_{2,T1}; . . . ; P_{N,T1}} and {P_{1,T2}; P_{2,T2}; . . . ; P_{N,T2}}, and
determining that δ₁ has approximately the same value as said nonzero amount and that each of {δ₂; . . . ; δ_{N}} are approximately zero, and
based on this determination, determining the first connection configuration to be that the electric vehicle is connected to the first phase of the power distribution system and not connected to any of the other phases of the power distribution system.

5. The method according to claim 3, comprising
at a first time at which the first electric vehicle is not charging, determining, for each said phase of the power distribution system a total amount of charging resources that the power distribution system provides to said electric vehicles thus obtaining {P_{1,T1}; P_{2,T1}; . . . ; P_{N,T1}}, wherein P_{k,T1}, indicates the total amount of charging resources provided to the electric vehicles via a k^{th} phase at the first time, k being an integer between 1 and N, and then
at a second time at which the first electric vehicle is charging, determining again, for each said phase of the power distribution system a total amount of charging resources that the power distribution system provides to said electric vehicles thus obtaining {P_{1,T2}; P_{2,T2}; . . . ; P_{N,T2}}, wherein P_{k,T2}, indicates the total amount of charging resources provided to the electric vehicles via the k^{th} phase at the second time, and
measuring said N values for the first electric vehicle, wherein one value of the N values indicates a nonzero amount of charging resources being provided to the first electric vehicle via an unspecified phase and the other one or more values of the N each indicate zero charging resources being provided via an unspecified phase to the first electric vehicle, and
based on {P_{1,T1}; P_{2,T1}; . . . ; P_{N,T1}} and/or on {P_{1,T2}; P_{2,T2}; . . . ; P_{N,T2}}, determining for each said phase of the power distribution system, a further amount of charging resources {P′₁; P′₂; . . . ; P′_{N}} by taking into account that one or more of said electric vehicles, having known connection configurations, are provided less or more charging resources at the second time than at the first time,
based on this determination, determining the first connection configuration to be that the electric vehicle is connected to the first phase of the power distribution system and not connected to any of the other phases of the power distribution system.

6. The method according to claim 1, wherein allocating the charging resources to the electric vehicles comprises
determining that each phase in the first subset of phases of the power distribution system has a respective unallocated capacity of charging resources, each respective unallocated capacity being equal to or higher than a first amount of charging resources, and
based on this determination, allocating the first amount of charging resources to the first electric vehicle.

7. The method according to claim 6, wherein determining that each phase in the first subset of phases has a respective unallocated capacity of charging resources comprises
for each phase of the power distribution system, determining a total amount of allocated charging resources via that phase, this step comprising summing respective allocated amounts of charging resources, which respective amounts are allocated to respective electric vehicles via that phase, and
comparing each determined total amount of allocated charging resources of one said respective phase with a respective total capacity associated with each said respective phase.

8. The method according to claim 1, comprising
determining an unknown second connection configuration for a second electric vehicle out of the plurality of electric vehicles by discovering that the second electric vehicle is connected to a third subset of one or more of said phases of the polyphase power distribution system and not connected to a fourth subset of one or more of said phases of the polyphase power distribution system, wherein
said first subset of said one or more phases comprises a first phase of the power distribution system,
the second subset of said one or more phases comprises a second phase of the power distribution system,
the third subset comprises the second phase, and
the fourth subset comprises first phase, and
based on the determined first connection configuration and the second connection configuration, allocating charging resources to the second electrical vehicle.

9. The method according to claim 1, further comprising
before determining the first connection configuration, allocating a certain amount of charging resources to the first electric vehicle, and then
for each said phase of the power distribution system, determining a total amount of allocated charging resources via that phase, this step comprising summing respective allocated amounts of charging resources, which respective amounts are allocated to respective electric vehicles via that phase, wherein
each determined total amount of allocated charging resources determined for each phase of the power distribution system contains said certain amount, and thereafter
based on determining the first connection configuration, reducing, for each phase that is in the second subset, the determined total amount of allocated charging resources for that phase by said certain amount.

10. The method according to claim 8, further comprising
after reducing each total amount of allocated charging resources for each phase in the second subset by said certain amount,
determining that each phase in said third subset of phases of the power distribution system has a respective unallocated capacity of charging resources, each respective unallocated capacity being equal to or higher than a second amount of charging resources, and
based on this determination, allocating the second amount of charging resources to the second electric vehicle.

11. A system for allocating charging resources to a plurality of electric vehicles connected to a polyphase power distribution system for receiving said charging resources, the system comprising
said polyphase power distribution system, and
a plurality of electric vehicle supply equipment's (EVSEs), configured to connect to respective said electric vehicles for charging the electric vehicles, and
a control system that is configured to control an amount of charging resources, provided by each said EVSE, to connected ones of said electric vehicles, wherein
the control system is configured to perform the method according to claim 1.

12. The system according to claim 11, wherein
the polyphase power distribution system has N number of phases, N being higher than one, the system comprising
a main meter that is configured to measure, for each said phase of the power distribution system, a total amount of charging resources that that phase provides to the plurality of electric vehicles, and
a plurality of local meters associated with the respective plurality of electric vehicle EVSEs, each local meter being configured to measure, for its associated said EVSE, N values, each value indicating an amount of charging resources provided to that EVSE via an unspecified phase of the power distribution system.

13. A data processing system comprising a processor that is configured to perform the method according to claim 1.

14. A computer program comprising instructions which, when the program is executed by a computer, cause the computer to carry out the method according to claim 1.

15. A non-transitory computer-readable storage medium having stored thereon the computer program of claim 14.

16. The method according to claim 2, wherein the polyphase power distribution system has N number of phases, N being higher than one, the method comprising
for each phase of the power distribution system, determining a total amount of charging resources that the power distribution system provides to said electric vehicles, and
for each said electric vehicle of said electric vehicles, determining N values, each value indicating an amount of charging resources provided to that electric vehicle via an unspecified phase of the power distribution system,
based on said determined total amounts of charging resources for the respective phases of the power distribution system and based on said determined N values for the electric vehicles, deducing the first connection configuration.

17. The method according to claim 16, comprising
at a first time at which the first electric vehicle is not charging, determining, for each said phase of the power distribution system, a total amount of the charging resources that the power distribution system provides to said electric vehicles thus obtaining {P_{1,T1}; P_{2,T1}; . . . ; P_{N,T1}}, wherein P_{k,T1}, indicates the total amount of charging resources provided to the electric vehicles via a k^{th} phase at the first time, k being an integer between 1 and N, and then
at a second time at which the first electric vehicle is charging, determining again, for each said phase of the power distribution system, a total amount of charging resources that the power distribution system provides to said electric vehicles thus obtaining {P_{1,T2}; P_{2,T2}; . . . ; P_{N,T2}}, wherein P_{k,T2}, indicates the total amount of charging resources provided to the electric vehicles via the k^{th} phase at the second time,
determining said N values for the first electric vehicle, wherein one value of the N values indicates a nonzero amount of charging resources being provided to the first electric vehicle via an unspecified phase and the other one or more values of the N values each indicate approximately zero charging resources being provided via an unspecified phase to the first electric vehicle,
determining a difference {δ₁; δ₂; . . . ; δ_{N}} between {P_{1,T1}; P_{2,T1}; . . . ; P_{N,T1}} and {P_{1,T2}; P_{2,T2}; . . . ; P_{N,T2}}, and
determining that δ₁ has approximately the same value as said nonzero amount and that each of {δ₂; . . . ; δ_{N}} are approximately zero, and
based on this determination, determining the first connection configuration to be that the electric vehicle is connected to the first phase of the power distribution system and not connected to any of the other phases of the power distribution system.

18. The method according to claim 16, comprising
at a first time at which the first electric vehicle is not charging, determining, for each said phase of the power distribution system a total amount of charging resources that the power distribution system provides to said electric vehicles thus obtaining {P_{1,T1}; P_{2,T1}; . . . ; P_{N,T1}}, wherein P_{k,T1}, indicates the total amount of charging resources provided to the electric vehicles via a k^{th} phase at the first time, k being an integer between 1 and N, and then
at a second time at which the first electric vehicle is charging, determining again, for each said phase of the power distribution system a total amount of charging resources that the power distribution system provides to said electric vehicles thus obtaining {P_{1,T2}; P_{2,T2}; . . . ; P_{N,T2}} wherein P_{k,T2}, indicates the total amount of charging resources provided to the electric vehicles via the k^{th} phase at the second time,
measuring said N values for the first electric vehicle, wherein one value of the N values indicates a nonzero amount of charging resources being provided to the first electric vehicle via an unspecified phase and the other one or more values of the N each indicate zero charging resources being provided via an unspecified phase to the first electric vehicle, and
based on {P_{1,T1}; P_{2,T1}; . . . ; P_{N,T1}} and/or on {P_{1,T2}; P_{2,T2}; . . . ; P_{N,T2}}, determining for each said phase of the power distribution system, a further amount of charging resources {P′₁; P′₂; . . . ; P′_{N}} by taking into account that one or more of said electric vehicles, having known connection configurations, are provided less or more charging resources at the second time than at the first time, and
based on this determination, determining the first connection configuration to be that the electric vehicle is connected to the first phase of the power distribution system and not connected to any of the other phases of the power distribution system.

19. The method according to claim 5, wherein based on {P_{1,T1}; P_{2,T1}; . . . ; P_{N,T1}} and/or on {P_{1,T2}; P_{2,T2}; . . . ; P_{N,T2}}, said determination for each said phase of the power distribution system of the further amount of charging resources {P′₁; P′₂; . . . ; P′_{N}} by taking into account that one or more of said electric vehicles, having known connection configurations, are provided less or more charging resources at the second time than at the first time, is carried out in accordance with {P′₁; P′₂; . . . ; P′_{N}}={P_{1,T2}; P_{2,T2}; . . . ; P_{N,T2}}−{EV₁; EV₂; . . . ; EV_{N}},_{change}, wherein EV_{k,change} indicates a total difference between (i) the amount of charging resources provided via the k^{th} phase at the first time to electric vehicles having known connection configurations, and (ii) the amount of charging resources provided via the k^{th} phase at the second time to the electric vehicles having known connection configurations,
determining a difference {δ₁; δ₂; . . . ; δ_{N}} between (i) {P_{1,T1}; P_{2,T1}; . . . ; P_{N,T1}} or {P_{1,T2}; P_{2,T2}; . . . ; P_{N,T2}} and (ii) {P′₁; P′₂; . . . ; P′_{N}}, and
determining that δ₁ has approximately the same value as said nonzero amount and that each of {δ₂; . . . ; δ_{N}} are approximately zero.

20. The method according to claim 18, wherein based on {P_{1,T1}; P_{2,T1}; . . . ; P_{N,T1}} and/or on {P_{1,T2}; P_{2,T2}; . . . ; P_{N,T2}}, said determination for each said phase of the power distribution system of the further amount of charging resources {P′₁; P′₂; . . . ; P′_{N}} by taking into account that one or more of said electric vehicles, having known connection configurations, are provided less or more charging resources at the second time than at the first time, is carried out in accordance with {P′₁; P′₂; . . . ; P′_{N}}={P_{1,T2}; P_{2,T2}; . . . ; P_{N,T2}}−{EV₁; EV₂; . . . ; EV_{N}},_{change}, wherein EV_{k,change} indicates a total difference between (i) the amount of charging resources provided via the k^{th} phase at the first time to electric vehicles having known connection configurations, and (ii) the amount of charging resources provided via the k^{th} phase at the second time to the electric vehicles having known connection configurations,
determining a difference {δ₁; δ₂; . . . ; δ_{N}} between (i) {P_{1,T1}; P_{2,T1}; . . . ; P_{N,T1}} or {P_{1,T2}; P_{2,T2}; . . . ; P_{N,T2}} and (ii) {P′₁; P′₂; . . . ; P′_{N}}, and
determining that δ₁ has approximately the same value as said nonzero amount and that each of {δ₂; . . . ; δ_{N}} are approximately zero.
